(19) United States
(12) Patent Application Publication
(10) Pub. No.: US 2015/0075494 A1
(43) Pub. Date: Mar. 19, 2015

(54) Filter Device for Absorbing a Water Fraction Contained in a Liquid

(71) Applicant: MANN+HUMMEL GMBH, Ludwigsburg (DE)

(72) Inventors: Sascha Bauer, Auenwald (DE); Markus Beylich, Ludwigsburg (DE); Karlheinz Muenkel, Oberderdingen-Flehingen (DE)

(21) Appl. No.: 14/550,945

(22) Filed: Nov. 22, 2014

Related U.S. Application Data
(63) Continuation of application No. PCT/EP2013/058433, filed on Apr. 24, 2013.

(30) Foreign Application Priority Data
May 22, 2012 (DE) 10 2012 009 999.1

(51) Int. Cl. F02M 37/22; B01D 35/147; B01D 15/10

(52) U.S. Cl. CPC F02M 37/22; B01D 15/10; B01D 35/147
USPC 123/445; 210/433.1; 210/149; 210/138; 210/143; 210/85; 210/95

(57) ABSTRACT

A filter device is provided with a housing and an absorption material received in the housing. The absorption material absorbs and stores a water fraction of a liquid being passed through the absorption material. A bypass is arranged in the housing so that the absorption material can be bypassed. A throttling device correlated with the bypass controls flow through the bypass. The throttling device is a passive throttling element or an adjustable valve.

### CROSS-REFERENCE TO RELATED APPLICATIONS

This application is a continuation application of international application No. PCT/EP2013/058433 having an international filing date of 24 Apr. 2013 and designating the United States, the International Application claiming a priority date of 22 May 2012, based on prior filed German patent application No. 10 2012 009 999.1, the entire contents of the aforesaid international application and the aforesaid German patent application being incorporated herein by reference.

### BACKGROUND OF THE INVENTION

The invention concerns a filter device for storing a water fraction of a liquid, in particular for filtering fuel for an internal combustion engine and storing a water fraction contained in the fuel. The filter device comprises a housing in which an absorption material is accommodated that can be flowed through by a liquid that contains a water fraction wherein the water fraction can be stored within the absorption material.

DE 196 05 433 A1 discloses a filter device for water absorption in hydraulic liquids. The filter device comprises a filter layer with water-absorbing polymers, so-called superabsorbent polymers, which are capable of absorbing water in amounts of a multiple of their own volume. The hydraulic oil, in contrast, can pass through the filter layer. The filter device is arranged with in a bypass of the hydraulic circuit.

DE 10 2009 057 478 A1 discloses a fuel filter device that comprises, arranged in a housing, a fuel filter and a water storage device with a superabsorbent polymer as a filter layer which has the task of filtering out the water fraction from the fuel.

The object of the invention is to configure with simple constructive measures a filter device for absorption of the water fraction contained in a liquid in such a way that, on the one hand, a high efficiency is provided and, on the other hand, the pressure loss upon flow through the filter device is limited.

### SUMMARY OF THE INVENTION

In accordance with the present invention, this is achieved in that a bypass for bypassing the absorption material is provided in the housing.

The filter device according to the invention is used for absorption of the water fraction in a liquid, for example, the water fraction contained in fuel, preferably diesel fuel, optionally also gasoline for an internal combustion engine. The filter device can also be used for water absorption in hydraulic liquids.

The filter device comprises an absorption material arranged in a housing and designed for absorption of water. Such absorption materials are known under the term superabsorbent polymers and are comprised, for example, of hydrophilic polymer fibers which absorb water and thereby swell. Usually a quantity of water that is a multiple of the volume of the absorption material can be absorbed. When absorbing water, the material polymerizes and encloses thereby the water. The hydrophilic fibers can be embedded optionally in a nonwoven support material.

A bypass is introduced into the housing of the filter device by means of which the supplied liquid which comprises the water fraction can bypass the absorption material. This broadens significantly the spectrum of use and the procedural possibilities of the filtering device for water absorption. For example, it is possible to bypass the saturated absorption material via the bypass so that the flow resistance of the liquid, from which the water fraction is to be removed, into the filter device is significantly reduced. When the absorption material is saturated, the supplied liquid no longer must take the path through the absorption material but instead, by bypassing the absorption material, can flow out via the bypass. Pressure losses are thereby avoided.

The filter device is located preferably within the main flow path of the liquid, from which the water fraction is to be removed, to a device in which the liquid is to be further processed. In principle, an arrangement of the filter device in a bypass flow path is possible also, for example, in the return flow path or connecting line between the main flow path and a liquid container, for example, a fuel tank.

It is possible to provide passive as well as active embodiments of throttle devices or valves in the filter device. In case of passive embodiments, an active adjustment of a switching member of the valve is omitted. In case of active embodiments, the switching member of the valve is adjusted by external energy supply wherein the adjustment optionally is realized by means of signals of a control unit in the context of a closed loop circuit. However, possible are also active embodiments without control unit in which, solely by changes within the filter device, an adjustment of the switching member of the valve is realized, for example, by the swelling action of the absorption material with increasing saturation level.

In a passive embodiment without adjustable flow control valve, the supplied fluid, as a result of the increased flow resistance upon saturation of the absorption material, automatically flows through the bypass that has a flow resistance that is reduced compared to that of the saturated absorption material but higher than that of the unsaturated absorption material. Preferably, in the bypass or in the inflow area of the bypass, a throttling device for increasing the flow resistance is seated.

It is expedient to provide in the housing of the filter device a common inflow opening for supply of the fluid containing a water fraction and to connect the bypass as well as the inflow side of the absorption material with the inflow opening. Possible is also an embodiment in which the fluid first flows to the inflow side of the absorption material through the inflow opening in the housing and from there is guided in the direction of the bypass in case that the flow resistance through the absorption material is too great as a result of saturation. These embodiments have the advantage that an adjustable valve for adjusting or regulating the flow through the absorption material or the bypass is not required.

In an active embodiment, on the other hand, an adjustable flow control valve is provided which is arranged downstream of the inflow opening in the housing and by means of which the flow path is affected. The flow control valve, for example, is designed as a thermovalve that, upon reaching a switching temperature, switches between open position and closed position, or a time-dependent switching valve that, after expiration of a defined time period, switches between open position and closed position. In this way, it is possible, for example, after cold start of an internal combustion engine, to initially keep open the bypass and guide at least most of the supplied fluid through the bypass thereby bypassing the absorption material. Only after a defined period of time or an increased temperature of the fluid, the flow control valve is moved from the open position into the closed position and the bypass is closed so that the fluid flows through the absorption material and the water fraction can be absorbed in the absorption material. As a thermovalve, a wax thermostatic element may be used.

In addition or as an alternative, a flow control valve for switching the flow path from the absorption material to the bypass may be provided which switches as a function of the saturation level of the absorption material. In this way, it is ensured that, as saturation of the absorption material is reached, the flow path through the bypass is opened and the fluid is discharged via the bypass by bypassing the absorption material. The saturation level of the absorption material can be determined in various ways, wherein basically a detection based on mechanical, thermal, electrical, visual or other means is possible. For example, it is also possible to employ the swelling behavior of the absorption material for switching the switching member of the flow control valve in order to adjust the flow control valve to a position in which the bypass is open. For example, the switching member of the flow control valve, when a defined saturation level is reached, can be switched by the swelling action of the absorption material such that the bypass is opened and the liquid, by bypassing the absorption material, is flowing out through the bypass. Before the saturation level is reached, the flow control valve is in a position in which the bypass is blocked so that the fluid must flow through the absorption material.

Optionally, a first switching valve, for example, a thermovalve or time-dependent valve, can be coupled with a second switching valve which is switched when the saturation level of the absorption material is reached. In this way, it is possible, for example, that at low temperatures the bypass is initially open; the bypass is closed only after a certain amount of time has passed or upon increasing temperatures so that the fluid then flows through the absorption material after said time or temperature events have occurred. Upon reaching the saturation level, the bypass is opened again so that the fluid flows out through the bypass and bypasses the absorption material. The first and the second flow control valves can be functionally coupled in that the second flow control valve that is switchable as a function of the saturation level also affect the first flow control valve and, for example, opens in order to open the bypass when the saturation level is reached.

The bypass, for example, is embodied as a central tube that extends centrally through the housing as well as through the absorption material. A throttling device, in particular in the form of a passive throttle element, may be correlated with the central tube in order to ensure that a minimum quantity of the fluid from which the water fraction is to be removed flows through the unsaturated absorption material and, only after reaching the saturation level, the fluid will flow through the throttle and the bypass.

The central tube can comprise a wall with flow openings on which the clean side of the absorption material is resting. The absorption material in this embodiment is flowed through in radial direction from the exterior to the interior wherein the radial outer side is the raw side and the radial inner side is the clean side of the absorption material. On the clean side, the absorption material directly adjoins the central tube wherein the fluid from which the water fraction has been removed can pass, via the flow openings provided in the wall of the central tube, into the bypass and can be discharged axially through the bypass.

According to a further expedient embodiment, the absorption material is received in a cage that is inserted into the housing of the filter device. The outer diameter of the cage is smaller than the inner diameter of the housing so that between the cage and the inner housing wall an annular flow space is formed by means of which inflow toward the absorption material is realized. In case that a central tube is arranged as a bypass in the filter device, flow through the absorption material is realized at least approximately in radial direction from the exterior to the interior. In principle, embodiments are also possible without a bypass or without a central tube; in this case, inflow toward the absorption material is realized still by the flow space between inner housing wall and exterior side of the absorption material in radial direction, but the discharge is realized via the end face of the absorption material.

Providing an annular flow space between the inner housing wall and the cage which accommodates the absorption material is advantageous because a safety buffer is formed in case of freezing of the separated water at freezing temperatures. By means of the safety buffer it is ensured that the volume that is increasing due to the freezing action is accommodated in the flow space and the surrounding housing is not damaged.

In order to be able to see the actual saturation level of the absorption material, the cage can be provided with at least two sections with different outer diameters wherein, depending on the saturation level, the absorption material as it swells will first pass in the section of smaller diameter through the openings in the cage wall and only subsequently, upon reaching a higher saturation level, the absorption material will also penetrate radially outwardly in the area of the greater cage diameter through the openings in the cage wall. Penetration through the cage wall can be detected in the different areas with different outer diameters either by sensors or visually in that, for example, at least one viewing port is provided in the wall of the housing of the filter device through which one can look from the exterior onto the cage. The viewing port is either a cutout in the wall of the housing or is comprised of a transparent material. This makes it possible to determine in a simple way the actual saturation level of the absorption material and to exchange the absorption material, as needed.

The cage may be enveloped by an envelope of nonwoven material that expediently is comprised of a highly active material and is capable of absorbing a relatively large quantity of water. This nonwoven envelope has a pre-storage function in that the water that is stored within the nonwoven envelope gradually is released into the absorption material.

On the outflow side of the absorption material, a protective nonwoven can be arranged in order to retain lose fibers of the absorption material and in order to prevent that such fibers are entrained in the purified liquid.

According to a further expedient embodiment, it is provided that the housing is combined of two symmetric housing parts. The housing is preferably cylindrical or at least embodied approximately cylindrical so that the two symmetric housing parts each are embodied in a cup shape and are to be joined with each other at their free end faces. Optionally, the absorption material including the cage is of a two-part configuration. Conceivable is also a single-part embodiment of the absorption material, for example, as a hollow cylinder and a two-part embodiment of the cage as well as of the housing.

The absorption material can also be configured in a folded form or as pressed member.

Upon use of the filter device for filtration of the fuel to be supplied to an internal combustion engine, the filter device is advantageously arranged upstream of a high-pressure pump in the fuel supply system of an internal combustion engine. The filter device is thus located at the low-pressure side of the high-pressure pump. In principle, it is also possible to arrange the filter device at the high-pressure side of the high-pressure pump.

### BRIEF DESCRIPTION OF THE DRAWING

FIG. 1 shows a schematic illustration of a fuel supply system of an internal combustion engine, comprising a filter device for storage of the water fraction in the fuel wherein the filter device is arranged upstream of a high-pressure pump.

FIG. 2 shows in an exploded illustration the filter device for absorption of the water fraction in the fuel, comprising a hollow cylindrical filter element of absorption material, a two-part cage accommodating the absorption material, and a two-part housing.

FIG. 3 shows the filter device in mounted position.

FIG. 4 is a section view in longitudinal direction of the filter device of FIG. 3.

FIG. 5 shows the filter device of FIG. 3 in a partial section view with indicated flow paths.

FIG. 6 shows a filter device for absorption of the water fraction in a further embodiment.

FIG. 7 shows the housing of the filter device according to FIG. 6 in an enlarged illustration.

FIG. 8 is a schematic illustration of the rim area of the cage accommodating the absorption material and of the enclosing housing.

FIG. 9 is an illustration similar to FIG. 8, showing also the absorption material, wherein the housing is of a different embodiment.

FIG. 10 shows a filter device with a first flow control valve and a second flow control valve in a bypass that is embodied as a central tube.

In the Figures, same components are identified with same reference characters.

### DESCRIPTION OF THE PREFERRED EMBODIMENTS

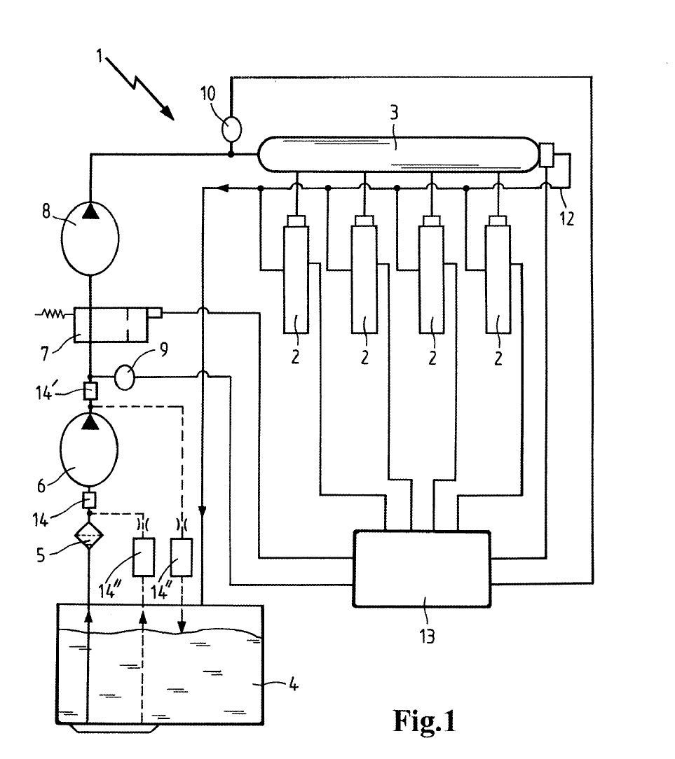

FIG. 1 shows a fuel supply system 1 for supply of fuel to an internal combustion engine, in particular for supply of diesel fuel. The fuel is injected by injectors 2 into the combustion chambers of the internal combustion engine wherein the injectors 2 receive the fuel from a high-pressure distributor pipe 3. The fuel originates from a fuel tank 4 and is conveyed from the fuel tank 4 via a fuel filter 5, a conveying pump 6, a pressure control valve 7, as well as a high-pressure pump 8 into the distributor pipe 3. In the fuel filter 5 a water separation device may be integrated in order to perform preseparation of the water fraction within the fuel.

Moreover, the fuel supply system 1 comprises a fuel temperature sensor 9 between the conveying pump 6 and the pressure control valve 7, a pressure sensor 10 between the high-pressure pump 8 and the distributor pipe 3, as well as a pressure limiter in a return line 12 between the distributor pipe 3 and the fuel tank 4. Also, a control unit 13 is correlated with the fuel supply system 1 which receives information and signals from the sensors or the adjustable devices and generates control signals for adjusting the devices.

A filter device 14 for absorption of the water fraction in the fuel is also arranged within the fuel supply system 1. The filter device 14 is located within the main flow path of the fuel between the fuel filter 5 and the conveying pump 6. Alternatively, the filter device 14′ can also be arranged downstream of the conveying pump 6. Also, an arrangement in a bypass flow path is conceivable, for example, in a suction line that branches upstream of the conveying pump 6 and opens into the fuel tank 4 (filter device 14″) or a return line that branches downstream of the conveying pump 6 and opens into the fuel tank 4 (filter device 14″′).

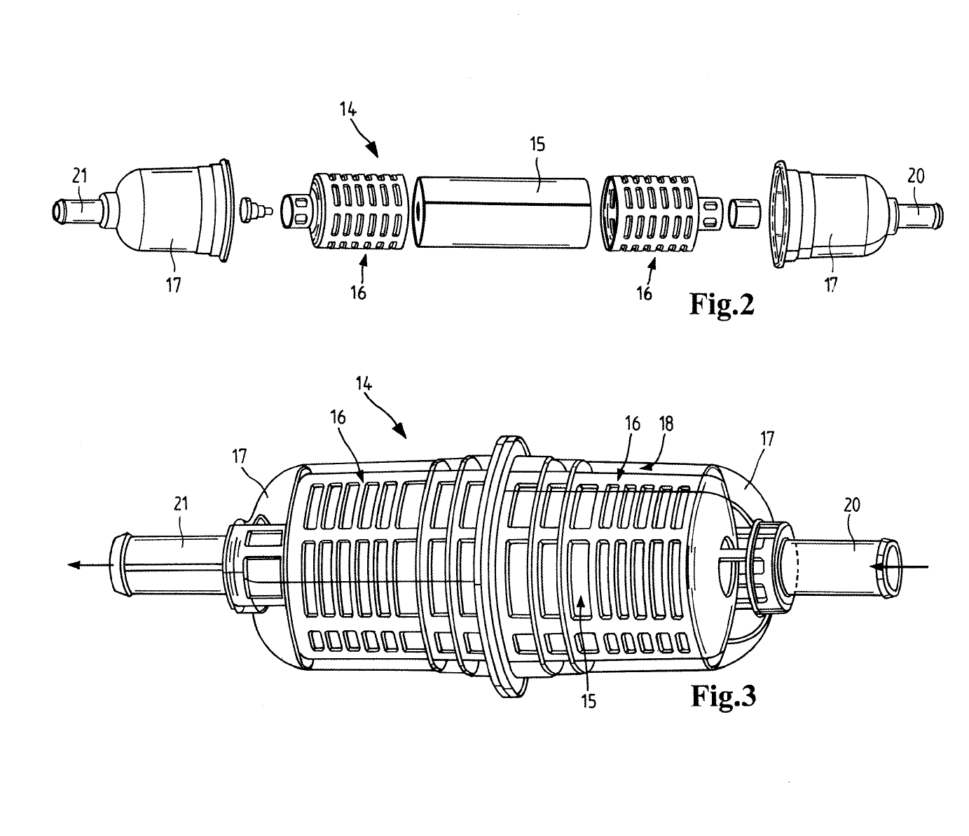

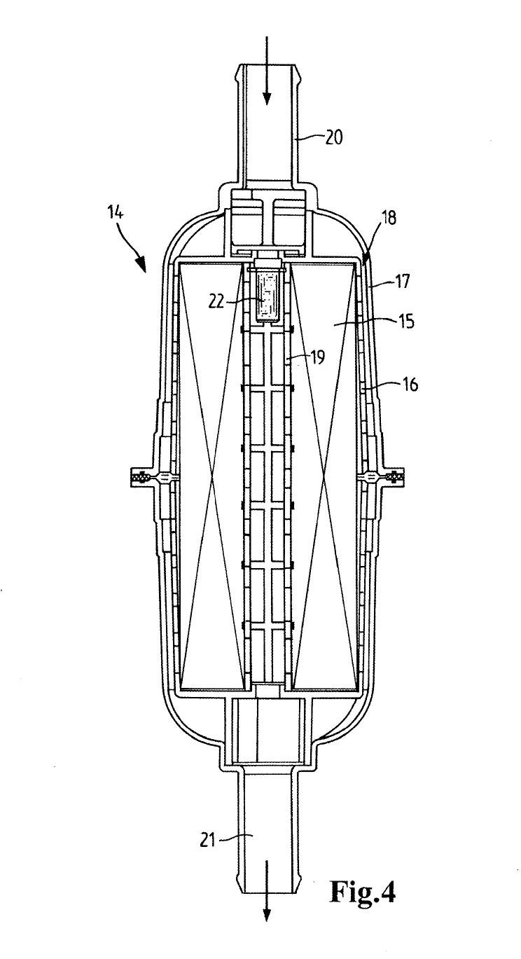

FIGS. 2 and 3 disclose that the filter device 14 comprises as a filter element an absorption material 15 in hollow cylindrical shape that is received in a cage 16 wherein the cage 16 including the absorption material 15 is inserted into a housing 17. The cage 16 can be of a two-part configuration; the housing 17 can also be of a two-part configuration. The cage 16 as well as the housing 17 are divided symmetrically so that the respective parts are of identical configuration relative to each other and can be produced with the same tools (molds). Flow through the filter device 14 occurs in axial direction as illustrated in FIGS. 3 and 4.

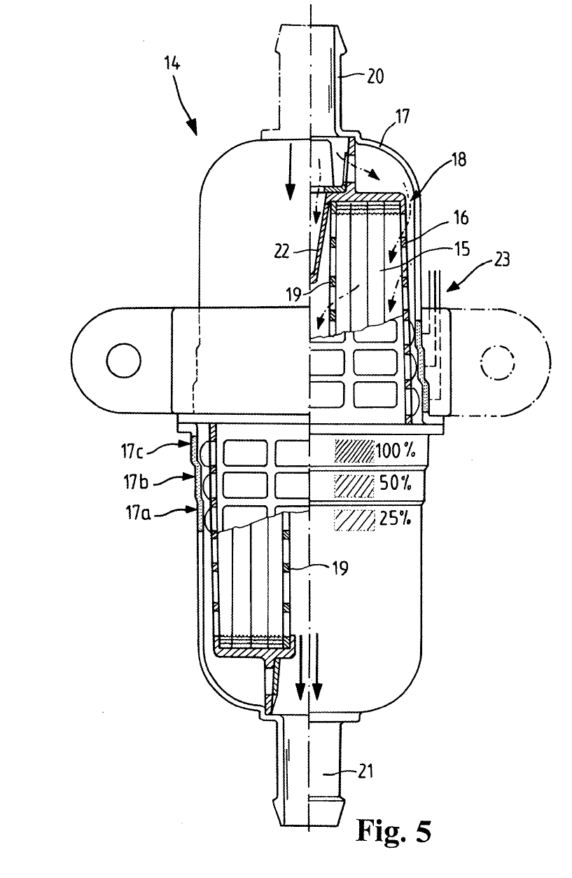

As can be seen in FIGS. 3 to 5, the outer diameter of the cage 16 is smaller than the inner diameter of the housing 17 so that between the exterior side of the cage 16 and the inner side of the housing 17 an annular flow space 18 is formed. The fluid to be purified flows through the absorption material 15, as shown in FIG. 5, radially from the exterior to the interior so that the radial outer side of the absorption material 15 is the raw side.

As can be seen in FIGS. 4 and 5, a central tube 19 is centrally arranged in the hollow cylindrical absorption material 15 and extends in axial direction. The central tube 19 forms a bypass bypassing the absorption material 15. In the wall of the central tube 19 a multitude of flow openings are provided by means of which the fluid purified within the absorption material 15 can flow into the central tube 19. Accordingly, the radial inner side of the absorption material 15 forms the clean side that is resting immediately on the central tube 19.

The fluid to be cleaned flows axially through the entire filter device 14. The supply of fluid into the housing 17 is realized by means of an inflow socket 20; the discharge of the purified fluid without water fraction or with reduced water fraction is realized by means of the discharge socket 21. The central tube 19 can be provided with a flow control valve 22 in the area of its end face that is neighboring the inflow socket 20; the flow control valve 22 can be switched between a closed position blocking the central tube 19 and an open position that opens the central tube 19. The adjustment of the flow control valve 22 is realized in particular as a function of the saturation level of the absorption material 15. In this context, as indicated in FIG. 5, a sensor device 23 can be integrated into the filter device 14 by means of which the saturation level of the absorption material 15 can be detected. Measurement of the saturation level of the absorption material is done, for example, electrically or optically.

As long as the absorption material 15 is not yet saturated, the flow control valve 22 is in closed position and therefore the bypass passage through the central tube 19 is closed. The fluid that is supplied through the inflow socket 20 flows into the annular flow space 18 between the exterior side of the cage 16 and the inner wall of the surrounding housing 17 and flows, viewed across the axial length of the absorption material 15, radially through the openings in the cage wall from the exterior to the interior. The water fraction in the fluid is absorbed in the absorption material 15. The fluid from which the water fraction has been removed flows radially into the central tube 19 and exits in axial direction the housing 17 through the discharge socket 21.

FIG. 5 shows furthermore that the housing 17 of the filter device 14 comprises, adjacent to the axial center, three different diameters 17a, 17b, and 17c that are axially neighboring each other. The diameters differ from each other with regard to the inner diameter and optionally also the outer diameter. On the other hand, the outer diameter of the cage 16 does not change in the axial direction or changes only minimally. In this way, the annular flow space 18 between the cage 16 and the inner wall of the housing 17 in the area of the sections 17a, 17b, and 17c has differently sized radial lengths into which the absorption material, which swells with increasing saturation level, can radially expand. The radial expansion of different magnitude depends on the saturation level of the absorption material and can be determined from the exterior. For this purpose, the wall of the housing 17 in the area of the sections 17a, 17b, 17c with different diameters is provided with a viewing port that makes it possible to visually detect from the exterior the actual radial expansion of the absorption material. The viewing port is either a section of the housing that is comprised of transparent material or is in the form of a cutout that is provided within the housing wall.

Each section 17a, 17b, 17c can have associated therewith a defined different level of saturation, for example, the section 17a with the smallest diameter can have associated therewith a saturation level of 25%, the section 17b with medium diameter a saturation level of 50%, and the section 17c with greatest diameter a saturation level of 100%. When the absorption material is contacting the inner wall of one of the sections 17a, 17b, 17c, the actual saturation level can thus be determined by means of visual control.

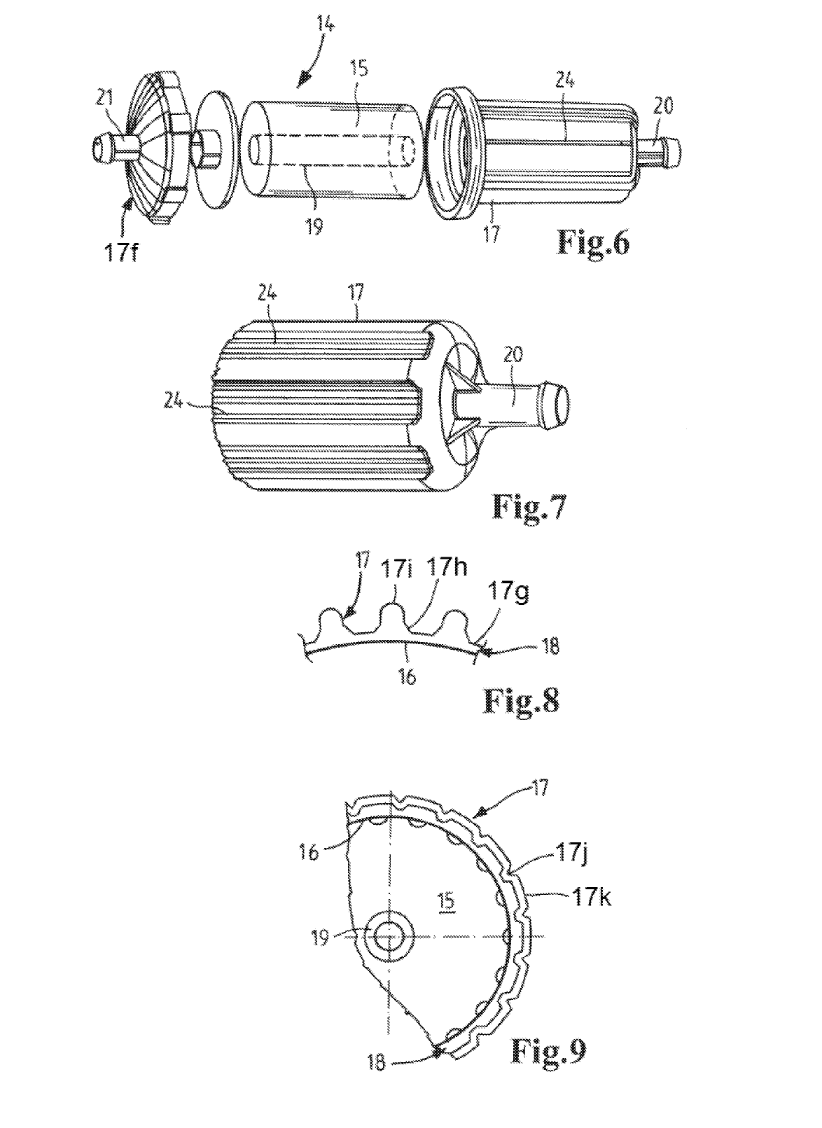

In FIGS. 6 and 7, a further embodiment for a filter device 14 is illustrated. In contrast to the preceding embodiment, the housing 17 of the filter device 14 is not symmetrically embodied. Instead, the housing 17 has a main housing which completely accommodates the absorption material 15 as well as a housing cover 17f that can be placed onto the housing 17 and connected thereto. The inflow socket 20 is monolithic with the housing 17, the discharge socket 21 is monolithic with the housing cover 17f.

FIGS. 6 and 7 moreover show that slot-shaped cutouts 24 are provided in the housing 17 and extend in longitudinal direction; the cutouts 24 form a viewing port in order to determine from the exterior whether the absorption material 15 has swelled which serves as a measure for the saturation level. Distributed about the circumference, several such slot-shaped cutouts 24 are provided in the wall of the housing 17.

In FIGS. 8 and 9, further embodiments for differently designed housings 17 are illustrated. According to FIG. 8, the housing 17 has a corrugated structure provided with corrugations peak 17i distributed about the circumference and radially projecting outwardly. Between them, corrugations valleys 17g are positioned wherein the corrugation valleys 17g are connected by connecting sections 17h with the corrugations peaks 17i. The sections 17g, 17h, and 17i each have a different diameter so that the annular flow space 18 between the housing 17 and the cage 16 positioned inside has accordingly differently sized radial lengths into which the absorption material can expand as it swells. By means of visual control, for example, through a viewing port of transparent material, the actual saturation level can be determined based on the contact area of the swelled absorption material on the inner wall of the housing 17.

In the embodiment according to FIG. 9, the housing 17 also has a corrugated structure but without distinct radially outwardly projecting corrugation peaks. Instead, according to FIG. 9, a radially inwardly extending depression 17j is provided in the wall of the housing 17 wherein a radially farther outwardly positioned section 17k is extending between two depressions 17j.

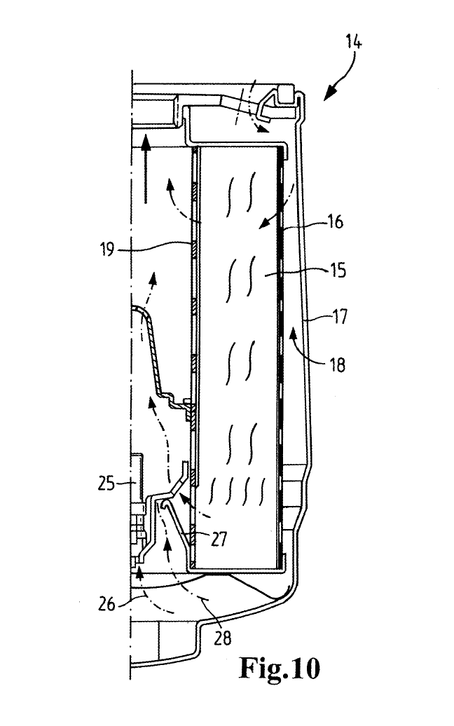

In FIG. 10, a further embodiment of a filter device 14 for absorption of the water fraction is illustrated. The filter device 14 is provided with a first flow control valve 25 and a second flow control valve 27 that each are arranged at the inflow side of the central tube 19. The first flow control valve 25 is a thermovalve that at low temperatures for starting the internal combustion engine is open and, when a limit temperature is reached, is moved into a closed position so that at low temperatures the bypass through the central tube 19 is open and, only when the limit temperature is reached, the bypass is closed so that the absorption material 15 is flowed through. When the thermovalve 25 is open, flow through the central tube 19 occurs according to arrow 26.

The second flow control valve 27 in the central tube 19 is controlled by the swelling action of the absorption material 15. In the unsaturated state of the absorption material 15, the second flow control valve 27 is in closed position so that by means of the second flow control valve 27 no flow through the bypass 19 and bypassing the absorption material 15 are possible. Only when the saturation level of the absorption material 15 has been reached, the absorption material begins to swell so that the actuating member of the flow control valve 27 is moved into the open position and the flow path axially through the central tube 19 is opened. Accordingly, independent of the actual state of the thermal valve 25, a flow path according to arrow 28 through the central tube 19 can be opened.

While specific embodiments of the invention have been shown and described in detail to illustrate the inventive principles, it will be understood that the invention may be embodied otherwise without departing from such principles.

What is claimed is:

1. A filter device comprising:
a housing;
an absorption material received in the housing, wherein the absorption material is configured to absorb and to store a water fraction of a liquid being passed through the absorption material;
a bypass arranged in the housing and configured to bypass the absorption material.

2. The filter device according to claim 1, further comprising a throttling device correlated with the bypass and configured to control flow through the bypass.

3. The filter device according to claim 2, wherein the throttling device is a passive throttling element.

4. The filter device according to claim 2, wherein the throttling device is an adjustable valve.

5. The filter device according to claim 4, wherein the adjustable valve is a thermovalve configured to switch between an open position and a closed position when a switching temperature of the thermovalve is reached.

6. The filter device according to claim 4, wherein the adjustable valve is a time-dependent switching valve.

7. The filter device according to claim 4, wherein the adjustable valve is adjusted by the absorption material, wherein an expansion of the absorption material adjusts the switching valve between an open position and a closed position.

8. The filter device according to claim 7, wherein, in addition to the adjustable valve that is switched by the absorption material, a switching valve is arranged within the bypass, wherein the switching valve is a thermovalve or a time-dependent valve.

9. The filter device according to claim 1, wherein the bypass comprises a central tube extending centrally through the housing and through the absorption material.

10. The filter device according to claim 9, wherein the central tube has a wall comprising flow openings, wherein the absorption material is configured to be flowed through by the liquid with the water fraction radially from an exterior to an interior of the absorption material and wherein a clean side of the absorption material is resting on the flow openings.

11. The filter device according to claim 1, further comprising a cage inserted in the housing, wherein the absorption material is arranged in the cage, wherein an exterior diameter of the cage is smaller than an inner diameter of an inner wall of the housing, and wherein an annular flow space is formed between the cage and the inner wall of the housing.

12. The filter device according to claim 11, wherein the cage comprises at least a first section and a second section, wherein the first section has a first outer diameter, and wherein the second section has a second outer diameter that is different from the first outer diameter.

13. The filter device according to claim 1, wherein the housing comprises at least a first section and a second section, wherein the first section has a first inner diameter, and wherein the second section has a second inner diameter that is different from the first inner diameter.

14. The filter device according to claim 1, wherein the housing comprises a wall and the wall comprises at least one viewing port.

15. The filter device according to claim 14, wherein the viewing port is a cutout in the wall of the housing.

16. The filter device according to claim 14, wherein the viewing port is comprised of a transparent material.

17. The filter device according to claim 1, wherein the housing is comprised of two symmetric housing parts.

18. The filter device according to claim 1, wherein the housing comprises a corrugated wall.

19. A fuel supply system for an internal combustion engine comprising a filter device according to claim 1 and further comprising a high-pressure pump, wherein the filter device is arranged upstream of the high-pressure pump.
